(19) United States
(12) Patent Application Publication
(10) Pub. No.: US 2015/0291315 A1
(43) Pub. Date: Oct. 15, 2015

(54) Device and Method for Nail Polish Color Identification

(71) Applicant: James McConnell, Redmond, OR (US)

(72) Inventor: James McConnell, Redmond, OR (US)

(21) Appl. No.: 14/682,997

(22) Filed: Apr. 9, 2015

Related U.S. Application Data
(60) Provisional application No. 61/977,476, filed on Apr. 9, 2014.

(51) Int. Cl. B65D 25/20; B05D 3/06; A45D 34/00

(52) U.S. Cl. CPC B65D 25/205; A45D 34/00; B05D 3/067; A45D 2034/007

(57) ABSTRACT

A system and method is provided for the positioning of UV cured nail polish held uncured within an opaque container, in a viewable cured and colorized section on the exterior of the container. The user, thus, has an accurate view of the colorized section which represents substantially the color of the material within the opaque container once also cured.

This application claims priority to U.S. Provisional Patent Application No. 61/977,476 filed on Apr. 9, 2014, and is incorporated herein in its entirety.

### 1. FIELD OF THE INVENTION

The present invention relates to polish employed on fingernails. More particularly, the invention relates to a color identification system for nail polish which is supplied in containers which block viewing of the contents because the polish held in the container must be sequestered from any light transmission to prevent initiation of curing and/or color change from transmitted light.

### 2. PRIOR ART

Nail polish, in modern America and in many countries throughout the world, is a popular way to make a fashion statement and to protect and nurture the fingernails. It is believed that nail polish originated in China and its use dates back thousands of years. For instance, during the Zhou Dynasty, the royal house preferred the colors gold and silver. However, red and black eventually replaced these metallic colors as royal favorites. During the Ming Dynasty, nail polish was often made from a mixture that included beeswax, egg whites, gelatin, vegetable dyes, and gum Arabic.

After the creation of automobile paint, nail polish in the United States was first produced by a company named CUTEX in or about 1917. In about 1932, the Charles Revson Company (later REVLON) produced their first nail polish. In addition to decorative coatings for the nails, nail polish was often used in the place of gloves to cover up the grime underneath finger and toe nails.

In recent forms of nail polish in the U.S. and other countries, nitrocellulose was a primary ingredient as it is a film-forming polymeric material which is dissolved in butyl acetate or ethyl acetate to form a liquid which may be applied with a brush to the nails and which will cure or dry to a substantially hard finish. This basic formulation expanded over time to include plasticizers to yield pliable films which once adhered to nails would bend with them and adhesive polymers to provide better adhesion to the nail surfaces. Dyes and pigments added to the mix yield the wide variety of colors available.

Since nail polish was introduced to the United States and most other countries, the color of the polish expected by the user on their nails is the color of the polish within the container when viewed through the clear glass of the container. Where the polish included sparkling agents or other solids, a quick shake of the container would yield a view to the user of what they could expect on their nails once applied.

In order to protect the color of the dried polish, in recent years ultraviolet stabilizers have been added to help resist color changes when the dried nail polish film on a user's nails is exposed to sunlight.

The application of polish in recent years has evolved to include multiple layers of polish. A first coat, or base coat, is employed conventionally as somewhat of a primer coat. This base coat can also include materials which will help strengthen the nails to which it adheres and to fill in imperfections in the nail surface.

Over this base coat, is placed one or a plurality of layers of a top coat. This coat employs the clear carrier material for the different colorants and which forms the colored coating to the nails once cured. The top coat may employ a conventional clear material or more recently thicker gel type top coats have been employed which use the UV light spectrum as a catalyst to harden the gel and yield longer lasting finish coats.

More recently, the nail polish industry has started using nail polishes and gels, which are cured with ultra violet emitting LEDs which emit light in the 405 nm visible spectrum to cure fingernail polish. However, the employment of this type of UV cured polish presents a problem in that it must be shipped, stored, and used from opaque containers which do not allow any light transmission to the contents of the container. This is because light transmission over time, will actually cure the nail polish within the container rendering it useless for its intended use on finger nails.

For nail professionals, and home users with access to curing lights, the provision of nail polish within opaque containers presents a vexing problem. As noted in nail polish of the past, the user was informed of the color of the polish by viewing the liquid polish in the transparent sidewalls of the container. However, with the advent of opaque sidewalls to protect the contained polish from all light spectrum, the user is left with no view of the contained polish when they are shopping for a particular color or when a client requests a particular color.

Some manufacturers have tried to solve this problem, by forming the container of glass or plastic which is opaque, but has a color on the exterior of the container, approximating the color of the contents. This has not worked well in that dying plastic or glass containers is more of an art than a science, and even where the manufacturer can approximate the container wall color to be approximately that of the contents, users are left with the need to guess if the color of the contents, once cured, will actually be the same as the plastic or glass forming the sidewall which has been colorized. In fashion, a guess is not something users wish to depend upon, especially when the contents can be a few shades different than the approximation of the colorized container.

Other manufacturers have endeavored to print the label for the opaque container in the color of the contents upon curing. However, printing varies due to color registration, varying colored inks from different manufacturers, and for a lot of other technical reasons. Consequently, printing labels in the approximate color of the cured polish contents, has been less than successful for users seeking to know, with certainty, what color the polish contents of the container will be when cured.

As such, users of current UV cured nail polish are left guessing if the colorized container wall, or the printed label, are a good approximation of the cured product on the nails. This requires guessing, estimation, and other actions which are not well received by clients when the polish on their nails drys two shades darker or two shades lighter than expected. Thus, nail professionals, as well as every day users with curing light access, are left to guessing, at present, what color the polish they apply will be once cured.

Consequently, what is needed to solve the shortcomings of prior art with regard to UV cured polish, is a container which provides a perfectly accurate rendering of what the actual color will be, of the cured contents of the container upon exposure to UV in the proper spectrum. Such a container should protect the contents from light transmission to prevent curing within the container. Such a container should provide the user with a view of the actual color of the cured contents which is 100% accurate thereby removing guesswork and estimation from the equation. Such a container, should maintain this accurate rendering viewable by the user until the contents of the container is totally depleted.

The forgoing examples of related and prior art and limitations related therewith are intended to be illustrative and not exclusive, and they do not imply any limitations on the invention described and claimed herein. Various limitations of the related art will become apparent to those skilled in the art upon a reading and understanding of the specification below for the novel nail polish container herein and the accompanying drawings.

### SUMMARY OF THE INVENTION

The device herein disclosed and described provides a solution to the shortcomings in prior art. The device and method herein, achieves the above noted goals through the provision of nail polish containers which are formed of opaque material in a color protecting the contents of the container, which include an actual cured section of nail polish material, in a user-viewable position on the exterior of the container.

The system herein, accomplishes this total accuracy in providing a viewable portion of the cured contents of the opaque container by continually sampling the contents deposited into respective containers during filling of the containers. Subsequent to mixing each lot or batch of nail polish liquid for placement of such into individual containers, a portion of the actual material used to fill each respective container in the lot, is concurrently portioned for positioning on an attachable substrate and for curing. The substrate containing the material from the lot deposited into the bottle, is cured on the substrate and then matched and placed upon the exterior of each opaque bottle containing a portion of the mixed batch. It is important to employ the actual material mixed in a lot or batch for filling the containers, to form a layer on a substrate adapted for engagement to the exterior of the opaque container.

In one preferred mode, a quantity of the mixed polish from a mixed batch, is deposited onto a first side of a substrate which is adapted on a first side for positioning and adherence of the polish, and configured on the opposite side for adherence to a surface of the opaque bottle. The mixed polish from the batch once covering the sheet of material is immediately exposed to UV light in substantially the 405 nm spectrum whereupon it cures immediately. The sheet of material is then cut into small sections which are adhered to individual bottles of the same batch of nail polish material as that which was applied to the sheet.

There are a number of modes in which to die cut the cured portions of material on the substrate depending upon whether a recess has been formed in the substrate for deposit and curing of the material, or if it has been placed on the first surface of the substrate for curing. A particularly preferred mode which was found during experimentation as being superior in rendition of the cured material color is that of die cutting through the cured material on the substrate whereby the perimeter edge of the cured material, is not surrounded by any substrate material.

Another favored mode is to position the material to be cured on the substrate in positions which have been colorized in a manner such that light refracted through the cured material will not affect the true color as it would appear on the user's nails. A colorized position on the substrate which is grey or black or a similar neutral color which will not reflect through the cured material has shown to be preferable especially with lighter tones of the cured material where a white substrate will reflect light back through the cured material and give a false rendering.

In the mode of positioning of the material being cured on the substrate where a recess is formed in the substrate layer, it has been found that the amount positioned within the recess should rise to the edge of the recess substantially level with the first surface. In that fashion, when cured, the cured material will shrink slightly and have a top surface which falls slightly below the first surface of the substrate which provides protection to the exposed surface of the cured material during shipping and display.

In another mode of the system and method herein, during filling of each bottle, the material to provide the visual display of actual color of the bottle contents is positioned directly a label adhered to the bottle which provides the substrate. The material is placed using a spray nozzle configured to position a small section upon a label or the exterior of the container in preferably section having a circular perimeter because such has been found to be better able to resist peeling and chipping during shipping and display of the bottle over rectangular and other shapes where corners or points on the perimeter have been found to chip more easily.

The exterior of the bottle or label substrate in the section wherein the spray of material is deposited, is immediately exposed to the 405 nm light spectrum whereupon the small section of material which is identical to the bottle contents, cures in place. The small section so sprayed and being formed of the identical material from the batch of material which is concurrently filling the container, thereby provides a colorized section viewable by the buyer or user which is identical to the color of the bottle contents when cured.

The spray nozzle can be provided with a pressurized stream of the material filling the bottle using a conduit through which the material filling the container is concurrently communicated to the spray nozzle. Such a nozzle may be employed to position the bottle contents material on substrates not already adhered t the bottle also, or brushes or other dispensers for the contents material to deposit a measured portion on the bottle or substrate.

Using the material applied to and cured on the adhesive sheet, or by using a spray nozzle which cures a sprayed spot of material from a nozzle, the same nail polish material filling the container will always dry to the exact color of the section of sprayed material, or the material placed in small sections adhered to the exterior of each container. Thus, users will be provided with a viewable section of cured material on the exterior of the container, which is identical to the contents of the container.

With respect to the above description, before explaining at least one preferred embodiment of the herein disclosed color matching invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other UV cured polish color displaying containers, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of this invention to provide nail polish users an opaque container for protecting the contents of UV cured nail polish, which also provides an viewable section showing an accurate actual color of the unseen polish contents within the bottle.

It is another object of this invention to achieve substantially one hundred percent accuracy in the color presented on the exterior of the container to that inside, by concurrently forming the rendered section of colored polish for the container during filling of the container with the same material.

Additional objects of the invention will be brought out in the following part of the specification, wherein detailed description is for the purpose of fully disclosing the invention without placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative rather than limiting.

In the drawings:

FIG. 1 depicts a mode of the invention wherein a colorized section is formed by spraying the identical material within the container in position on an applied substrate or the bottle exterior and curing it to a finish color.

FIG. 2 depicts a mode of the invention wherein a colorized section is formed by spraying the identical material concurrently being filled to the container, upon a substrate surface having an adhesive side, which is affixed to the container after material curing.

FIG. 3 depicts the method herein following the sheet applique or spray mode of concurrent placement of colorized section.

FIG. 4 is a sectional view example of a substrate having a plurality of cavities formed into a first surface for deposit of bottle material therein for curing.

FIG. 5 shows a mode of the system wherein the cured material for application to the bottle or label thereon, is first die cut to form a perimeter which is formed of the cured material.

FIG. 6 shows a mode of the system where the section of material cured for adherence to the bottle or label thereon, is deposited onto a substrate which is colorized in a neutral color 15 to minimize discoloration from light reflection and refraction.

FIG. 7 depicts a mode of the cured material for adherence to the bottle or label on the bottle which is formed withing a recess surrounded by the substrate on which it was cured.

FIG. 8 depicts the cured material of FIG. 5 wherein the die cut portion of cured material is adhered to the label on a bottle, or could be adhered to the bottle itself.

FIG. 9 is an example of the cured material as in FIG. 6 or 7 wherein it is cured within a recess formed in an adherable substrate and surrounded by a the substrate.

FIG. 10 shows the section of material cured within a recess on a substrate employed for the label on the bottle or container.

### DETAILED DESCRIPTION OF THE PREFERRED EMBODIMENTS OF THE INVENTION

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

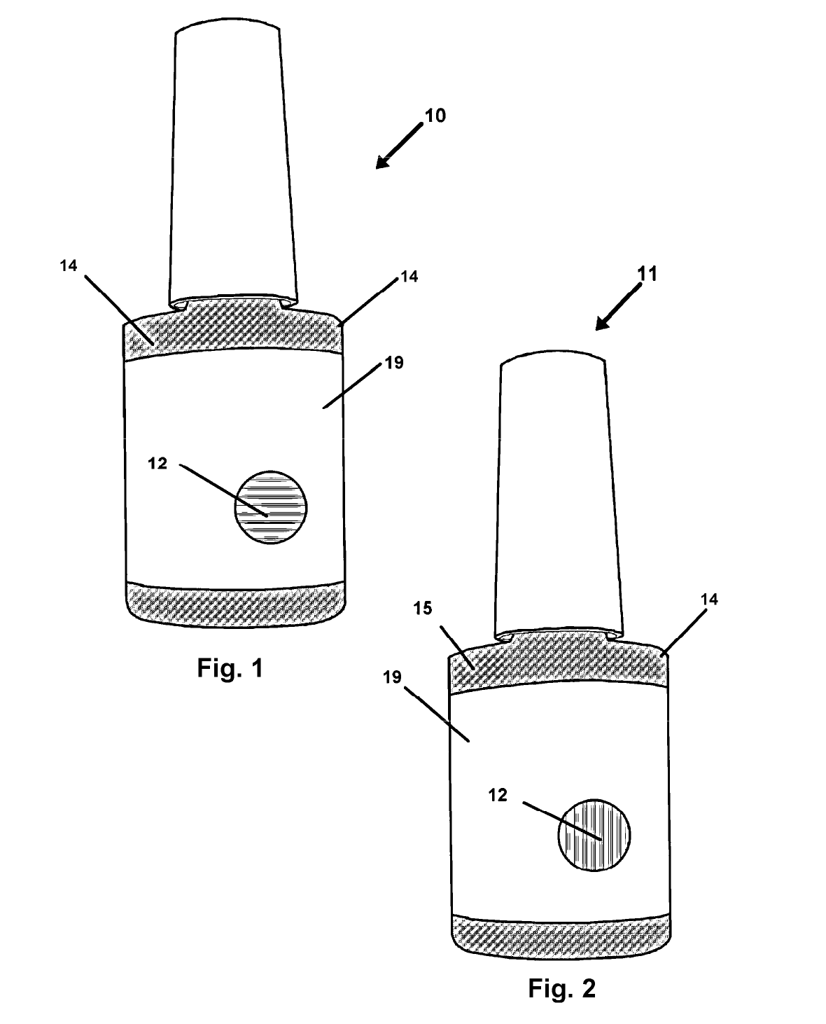

Now referring to drawings in FIGS. 1-10, wherein similar components are identified by like reference numerals, there is seen in FIG. 1, one preferred mode of the device 10 herein wherein a colorized section 12 is formed by spraying the identical UV cured polish material filled and held within the opaque container 14, directly into a position on the exterior of the container 14 or in the depicted mode, upon a label 19 already adhered to the container 14.

The colorized section 12 as noted and shown in FIG. 1, may be sprayed into position concurrent with the container being filled with the same material communicated to the sprayer spraying the colorized section 12 in place. Once positioned and formed of the identical material filling the container 14, the colorized section 12 is cured using the appropriate UV light transmission to the colorized section 12. As noted, it has been found through experimentation, that a circular formation of the colorized section 12 is preferable, especially when die cut and not surrounded by substrate 13, rather than in a recess 17. However even when in a recess 17, it has been found that color rendition of the circular section 12 is more accurate due apparently to a more even light refraction and reflection from the cured material section 12 in this shape.

FIG. 2 depicts a mode of the device 11 herein, wherein a colorized section 12 is formed by depositing the identical material being filled to the container 14, upon a first surface of a substrate 13, or within a recess 17 formed in the substrate 13 which has means for attachment to the container such as adhesive 21 (FIG. 4-6) on an opposite side to the first surface. The colorized section 12 is then cured using appropriate UV light. As noted, if placed within a recess 17 it would be in a volume which is equal to or adjacent the edge of the recess and the first side surface such that when cured, the material forming the colorized section 12, will shrink slightly to have a top surface recessed below the perimeter edge of the recess 17 in which it cured.

The substrate 13 may be larger than the individual colorized sections 12 which may be cut from the substrate 13 such as in FIG. 4. The sections 12 would be die cut or otherwise cut from the substrate 13 and then appliqued to the surface of the container 14 or to the label 19 of the container 14. As noted in a particularly preferred mode as in FIGS. 5 and 8, the cut section 12 can have a perimeter edge which as noted is round, and formed of the cured material forming the section 12 rather than the substrate material as in FIGS. 6, 7 and 9.

In all modes of the device and system herein, the material being communicated into the containers 14, is concurrently employed in a fashion to form the colorized sections 12. Such thus, insures that the cured colorized sections 12 depict the exact color of the contents of the container when it is cured.

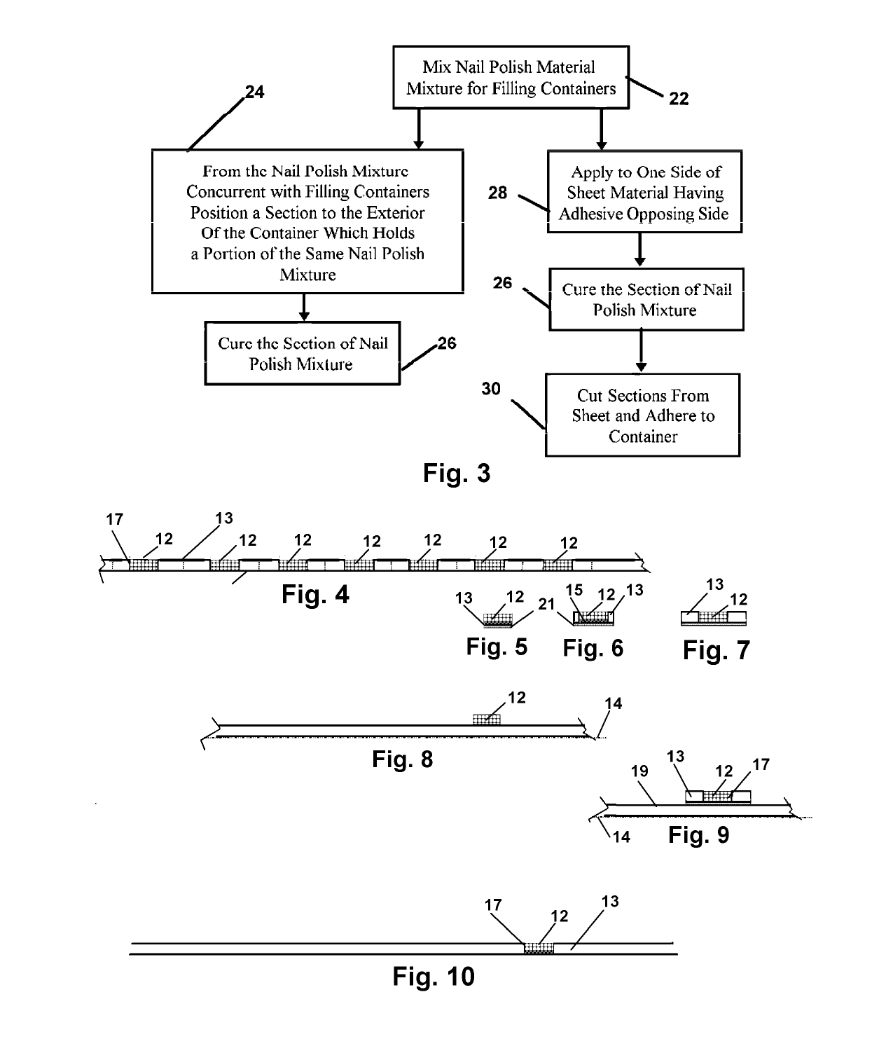

Shown in FIG. 3 depictions of two modes of the method herein which form the device of FIG. 1 and that of FIG. 2.

In a first mode of the method herein, the polish material is mixed 22 and readied for filling the containers 14. From the same mixed polish mixture being used to fill respective containers 14, a colorized section 12 of the material, is formed and is concurrently or subsequently positioned 24 upon the exterior of the container 14 or label 19. Positioning and/or forming the material into the section 12 in this fashion may be by sprayer, ink stamp, applique or other means to communicate the same mixed mixture filling the containers 14 to the position of the colorized section 12 on the exterior thereof.

If deposited directly to a container 14 or label 17 on the container in uncured form in order to form a colorized section 12 on the exterior of a container 14, the deposited material is subsequently exposed to UV light 26 to cure the deposited material into the final colorized section 12 and yield a perfect match to a cured color of the contents of the container 14.

In a second mode of the method herein, the nail polish material is mixed 22 to a mixture to fill the containers. From the batch being employed to fill a plurality of containers 14, a portion is deposited 28 to a first side of a substrate 13 having adhesive 21 on the opposing side. As noted the deposited uncured material may be directly onto the first side or surface of the substrate 13 or into a recess 17 having an opening edge at the first surface. It should be noted that the substrate 13 may also serve as the label 19 in some instances and that the substrate should be a flexible material adapted to the task herein such as one or a combination of materials from a group including paper, plastic, foil, shrinkwrap, or other materials to which the material deposited will adhere and cure to a colorized section 12.

Once so deposited, onto the substrate 13 or into the recess 17, the material is exposed to UV light 26 for the appropriate time to cure to a colorized section 12. In this mode, the colorized sections 12 may be formed individually, or in multiple sections 12 on a large substrate 13 such as in FIG. 4. The material so deposited and cured, may itself then be die cut, or the substrate 13 may be die cut or otherwise formed into container-adherable colorized sections 12.

It is noted and anticipated that although the device and method herein is shown in preferred modes, various components and aspects of the device and method may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A method for positioning a section of UV-cured nail polish on an exterior surface of a container formed of opaque walls defining a cavity for holding a supply of said nail polish therein, comprising the steps of:
mixing a batch of said nail polish;
depositing a first portion of said batch into each of said individual containers;
employing UV light to cure said nail polish into a group of cured individual sections formed of a second portion of said batch of nail polish;
positioning a respective said section from said group onto an exterior surface of each of said individual containers or upon a label adhered thereto; and
whereby a user of said nail polish held within a respective said container may ascertain a color of said first portion within said bottle once cured, by viewing said section.

2. The method for positioning a section of UV-cured nail polish of claim 1 additionally comprising:
forming each of said group of individual sections, directly upon said container or said label adhered thereto.

3. The method for positioning a section of UV-cured nail polish of claim 1 additionally comprising:
forming each of said group of individual sections by depositing individual portions of said second portion of said batch of nail polish, upon a first surface of a flexible substrate; and
cutting each said portion formed on said substrate into respective said sections; and
positioning said section formed upon said substrate upon said container.

4. The method for positioning a section of UV-cured nail polish of claim 2 additionally comprising:
forming said sections with a circular circumference.

5. The method for positioning a section of UV-cured nail polish of claim 2 additionally comprising:
cutting each said portion formed on said substrate into said sections having a circular circumference.

6. The method for positioning a section of UV-cured nail polish of claim 5 additionally comprising:
cutting through each said portion and said substrate on which it is deposited to form a said section having a perimeter edge formed solely of said second portion of said material.

7. The method for positioning a section of UV-cured nail polish of claim 3 additionally comprising:
depositing said portion of said second portion of said batch of nail polish into individual circular recesses formed into said first surface of said flexible substrate.

8. The method for positioning a section of UV-cured nail polish of claim 7 additionally comprising:
cutting through each said portion and said substrate on which it is deposited to form a said section having a perimeter edge formed solely of said second portion of said material which is not surrounded by said substrate.

9. The method for positioning a section of UV-cured nail polish of claim 3 additionally comprising:
depositing said individual portions of said second portion of said batch of nail polish, upon positions upon said first surface of a flexible substrate which are colorized in grey or black.

10. A nail polish container formed using the method of claim 1.

11. A nail polish container formed using the method of claim 7.
